(19) United States
(12) Patent Application Publication
(10) Pub. No.: US 2013/0233497 A1
(43) Pub. Date: Sep. 12, 2013

(54) Blind Assembly

(71) Applicant: Stephen William Birtles, Hazel Grove (GB)

(72) Inventor: Stephen William Birtles, Hazel Grove (GB)

(21) Appl. No.: 13/884,205

(22) PCT Filed: Nov. 18, 2011
(86) PCT No.: PCT/GB2011/001626

§ 371 Date: May 8, 2013

(30) Foreign Application Priority Data
Dec. 1, 2010 (GB) 1020331.3

(51) Int. Cl. E06B 9/264

(52) U.S. Cl. CPC E06B 9/264
USPC 160/89

(57) ABSTRACT

A blind assembly including a Roman blind sheet secured at one end thereof to a headrail, wherein the Roman blind sheet carries a plurality of horizontal bars arranged in a spaced relationship; and a roller blind sheet secured at one end thereof to a roller tube rotatably coupled to the headrail, the roller blind sheet including at the opposite end thereof a bottom bar, wherein the roller blind bottom bar is coupled to the Roman blind sheet such that rotation of the roller tube causes the roller blind sheet to be raised or lowered and a consequent raising or lowering of the Roman blind sheet.

The present invention relates to a blind assembly for covering architectural openings, such as windows or doors. In particular, the invention relates to a Roman blind, the deployment and retraction of which is controlled by a roller blind sheet.

Conventional Roman blinds incorporate lifting cords to raise and lower the blind fabric. These lifting cords typically form an array on the rear surface (i.e. the surface of the blind which faces away from the interior of a room) of the blind and are secured to certain of the horizontal bars which define the blind as a Roman blind. However, concerns have recently been raised about the safety of such an arrangement. More specifically, it has been found that the lifting cords can form a choking hazard for infants and small children. Children tend to be curious about their surroundings and have been known to insert their heads into loops formed by the lifting cords. If they inadvertently lose their balance or slip when their head is in a loop formed by the lifting cord, the blind cord can effectively become a noose for the child, resulting in serious injury, or, in the worst case, death.

Blind manufacturers have been working to reduce the risk of such injury in children.

One such attempt to address this issue is described in US 2010/0294438. In this document, a lifting sheet is secured to a blind fabric. However, this presents a number of problems itself: firstly, the divisional or securing bars are fixed to the blind fabric itself, which can result in unsightly fixings and can risk in the fabric being weakened at the fixing point. Secondly, the divisional bars do not extend across substantially the entire width of the blind fabric. Accordingly, the lifting sheet also does not extend across substantially the entire width of the blind fabric. This can lead to undesired aesthetic properties of the blind. Finally, and perhaps most importantly, the divisional bars themselves may form a choking hazard, as the sheet(s) can be laterally spaced from the bars to an extent that would allow a child or infant to insert their head between the bar and the sheet(s).

According to a first aspect of the invention, there is provided a blind assembly including a Roman blind sheet secured at one end thereof to a headrail, wherein the Roman blind sheet carries a plurality of horizontal bars arranged in a spaced relationship; and a roller blind sheet secured at one end thereof to a roller tube rotatably coupled to the headrail, the roller blind sheet including at the opposite end thereof a bottom bar, the roller blind bottom bar being coupled to the Roman blind sheet such that rotation of the roller tube causes the roller blind sheet to be raised or lowered and a consequent raising or lowering of the Roman blind sheet; wherein the horizontal bars extend across substantially the entire width of the Roman blind sheet and each horizontal bar includes a Roman blind fabric engagement element in the form of a fabric receiving slot extending substantially the entire length of the bar; wherein at least one of the horizontal bars further includes a channel-defining element which defines a channel between a body portion of the horizontal bar and the channel-defining element; and wherein the roller blind sheet is located in use within the channel.

In this arrangement, the roller blind sheet effectively acts as the array of lifting cords. Unlike conventional lifting cords, the roller blind sheet is incapable of forming a noose, thus reducing the risk of injury to a child.

The skilled person will appreciate that in this aspect of the invention, the Roman blind sheet will be the front sheet, i.e. the sheet which faces inwards into a room, and the roller blind sheet will form a rear sheet, i.e. the sheet which faces away from the interior of the room.

The use of two such sheets has the added advantage that visual effects and/or variations in the light transmission properties of the blind can be achieved that are not possible with a single blind sheet.

In the context of the present invention, the term “sheet” as used herein denotes a substrate which functions to control light transmission into a room. For example, the sheet may be formed from a woven fabric substrate, a non-woven fabric substrate, a continuous polymeric substrate, a laminated substrate comprising two or more individual sheet elements, or a so-called “woven wood” substrate.

When referring to the Roman blind sheet, reference is made to “horizontal bars”. These are sometimes referred to as “divisional bars” or “Roman bars”. In the context of this specification, the terms horizontal bars, divisional bars and Roman bars are considered to be synonymous.

At least one of the horizontal bars carried by the Roman blind sheet includes a channel-defining element, which defines a channel between a body of the horizontal bar and the channel-defining element itself, wherein the roller blind sheet is located in use within the channel. Thus, the or each channel allows the roller blind sheet to be slidably coupled to the Roman blind sheet. In other words, the roller blind sheet can move vertically relative to the Roman blind fabric and is slidably retained within the or each channel. Suitably, at least two of the horizontal bars include respective channel-defining elements.

In an embodiment, the channel-defining element defines a channel which extends substantially the entire length of the horizontal bar and the roller blind sheet is located within the channel.

Suitably, the roller blind sheet has a width (i.e. a horizontal dimension) which is substantially the same as the width of the Roman blind sheet. Accordingly, the channel-defining element suitably extends substantially the entire length of the horizontal bar in order to define the channel.

The use of a full width roller blind sheet (i.e. substantially the same width as the Roman blind sheet) may provide a more aesthetically pleasing product.

The channel-defining element typically extends substantially parallel to the horizontal bar, such that the element and an adjacent surface of the bar together define the channel. The channel-defining element may be arranged whereby a gap is defined between the bar and the element and the gap defines a depth of the channel. Suitably the channel-defining element extends substantially the entire length of the horizontal bar.

In embodiments where the roller blind bottom bar is used to raise and lower the Roman blind sheet, the channel is typically sized and configured to prevent the roller blind bottom bar from entering or passing through the channel. Thus, in use, the roller blind bottom bar engages the horizontal bars which include the channel-defining elements either directly or indirectly and causes these horizontal bars to rise or descend with the roller blind bottom bar. Accordingly, when the Roman blind sheet is to be retracted, the roller blind bottom bar is raised, which urges the horizontal bars including the channel-defining elements to rise with the bottom bar and when the Roman blind sheet is to be deployed, the roller blind bottom bar is lowered, which permits the horizontal bars including the channel-defining elements to descend to the extent permitted by the Roman blind sheet.

The channel-defining element may include a rotatable rod or tube. The rod or tube may be substantially hollow.

Furthermore, the rod or tube may be rotatably coupled to the horizontal bar such that it is capable of rotating about its longitudinal axis. In practice, the longitudinal axis of the channel-defining element will be a horizontal axis. The rod or tube being capable of rotation provides for a smoother action for the roller blind sheet, as the rod or tube is able to act as a roller which reduces the frictional forces between the roller blind sheet and the horizontal bar.

In an embodiment of the invention, the channel-defining element is releasably coupled to the body portion of the horizontal bar. Having the channel-defining element detachable from the horizontal bar further increases the safety aspects of the present invention, as any attempt by a child to insert its head between the roller blind sheet and the channel-defining element would result in the channel-defining element becoming detached.

Suitably, the relevant horizontal bar body portion includes a pair of mounting brackets and the channel-defining element is releasably coupled to the body portion of the horizontal bar via the brackets. The brackets may be located at each end of the horizontal bar. Each bracket may include a stub axle, i.e. a short shaft which in use extends into a cavity or hollow portion defined by the channel-defining element, upon which an end of the channel-defining element may be either fixed or rotatably mounted. Thus, the cavity of hollow portion defined by the channel-defining element which is adapted to receive the stub axle forms a bearing for the axle. The length of the stub axle may determine the force needed to detach the channel-defining element from the bracket—the longer the axle, the more force is needed to detach the channel-defining element.

An advantage of using a relatively short shaft to releasably couple the channel-defining element is that a force applied to the channel-defining element in any direction will cause the release of the channel-defining element from the respective mounting bracket.

Each bracket may form part of an end cap for the horizontal bar. Thus, the horizontal bar may include a pair of opposed end caps, each of which includes a mounting element for releasably coupling thereto one end of the channel-defining element. The mounting element may be in the form of a shaft which in use projects into a cavity or hollow portion of the channel-defining element (i.e. a stub axle).

In an alternative embodiment, the channel-defining element may include a cable, which extends substantially parallel to the horizontal bar, such that the cable and an adjacent surface of the bar together define the channel. The cable may be arranged whereby the gap is defined between the bar and the cable. Suitably the cable extends substantially the entire length of the horizontal bar.

A cable has the advantage that it is relatively easy to manufacture and makes the blind assembly relatively straightforward to install.

The term “cable” refers to an elongate element which may be deflected laterally. It may be formed from a single filament or from a plurality of filaments wound together. The filament or filaments may be formed from an extruded polymeric material, a metal wire or a plurality of fibres bound together. Suitably the cable is formed from one or more polymeric filaments and is translucent, more suitably, it is transparent.

In an embodiment of the invention, the channel-defining element further includes a pair of anchor portions and the cable is located between the anchor portions. Suitably, the cable is held between the anchor portions under tension. This arrangement allows the cable to function with horizontal bars that have relatively large tolerances regarding their length. The anchors may form opposed end caps for the horizontal bar. Thus each horizontal bar may include a pair of end caps, each carrying an anchor for the cable. The use of anchors between which the cable is located allows the cable to be coupled to horizontal bars of varying lengths.

The cable may include a shroud in the form of a coaxial sheath located around the cable. In an embodiment of the invention, the shroud is rotatably coupled to the cable such that the shroud is capable of rotating about its longitudinal axis relative to the cable. Suitably, the shroud extends substantially the entire length of the cable. In embodiments where the cable is translucent or transparent, the shroud may also be translucent or transparent, such that the combination of the cable and shroud together are translucent or transparent.

As mentioned above, a rotatably coupled shroud provides a roller-type effect and reduces friction as the roller blind sheet moves vertically through the channel.

As with conventional horizontal bars, the horizontal bar of the present invention is adapted to engage or grip the Roman blind sheet to define the characteristic folds in the sheet. Thus the horizontal bar includes a fabric receiving slot. Suitably a rod is located within the fabric receiving slot in use to prevent the unintentional or undesired removal of the Roman blind fabric portion from the slot. In such an embodiment, the fabric is typically wound around a portion of the rod and the rod is sized to prevent its removal laterally from the slot. Thus, the diameter of the rod is typically greater than the width of the longitudinal or lengthwise opening of the slot.

The channel-defining element may be carried by alternate horizontal bars. In other words, every other horizontal bar may include a channel-defining element. In such an embodiment, the horizontal bars including the channel-defining element (i.e. the “lifting” horizontal bars) are involved in the raising and lowering of the Roman blind sheet and the “intermediate” horizontal bars (i.e. those horizontal bars without the channel-defining element) ensure that the Roman blind sheet folds in a desired manner upon being raised. Thus, the horizontal bars which do not carry the channel-defining element (hereinafter the “intermediate” bars) cause the Roman blind fabric to fold and drape in an aesthetically pleasing way. Moreover, the effect of these intermediate horizontal bars allows a greater range of substrates to be used as Roman blind sheets. Accordingly, the Roman blind sheet may include a coated or impregnated sheet, wherein the sheet is coated or impregnated with a binder or polymeric resin. Additionally or alternatively, the Roman blind sheet may be a laminated sheet comprising two or more sheet elements adhered together. It is not usually possible to use such sheets as Roman blind sheets.

Conventionally, Roman blind fabrics or sheets are soft fabrics which are able to provide the desired drape effect under their own weight. However, such “soft” fabrics have a number of problems associated with them. By including the intermediate horizontal bars between the lifting horizontal bars (those which include the channel-defining element), it is possible to obtain the desired drape effect with fabrics or sheets that are coated, impregnated or laminated and are therefore stiffer compared with conventional Roman blind sheets. This is because each intermediate horizontal bar acts as a weighted bottom bar for the respective fold of the Roman blind sheet and pulls the fold into the desired configuration via the action of gravity. The ability to use sheets that are coated, impregnated or laminated addresses at least some of the problems usually associated with the use of soft, uncoated sheets.

In an embodiment of the invention, the Roman blind sheet includes a bottom bar. In a further embodiment of the invention, the Roman blind bottom bar and the roller blind bottom bar together form a common bottom bar. In this embodiment, the common bottom bar is fixed to both the Roman blind sheet and the roller blind sheet such that immediately the common bottom starts to rise as a result of the roller tube being rotated, the Roman blind sheet will start to rise.

In an alternative embodiment, the Roman blind bottom bar is separate to the roller blind bottom bar and the roller blind bottom bar is slidably coupled to the Roman blind sheet. In this embodiment, rotation of the roller tube will result initially in just the roller blind bottom bar being raised. This will continue until the roller blind bottom bar contacts a lifting horizontal bar, which defines a channel sized to prevent the roller blind bottom bar passing through it and within which is located the roller blind sheet. The Roman blind sheet only starts to rise upon engagement of the roller blind bottom bar with the first horizontal bar carrying a channel-defining element.

In the embodiment described immediately above, the roller blind bottom bar will engage successive lifting horizontal bars and thus raise the Roman blind sheet.

In an embodiment of the invention, the assembly further includes a drive wheel connected to the roller tube, a clutch and a manually operable operating chain connected to the drive wheel, such that the roller tube is capable of being rotated by the operating chain and the clutch is capable of preventing undesired rotation of the roller tube. This type of arrangement will be familiar to those skilled in the art of roller blinds, as it defines an arrangement which permits the roller blind to be raised or lowered manually by an operating chain. Accordingly, the blind assembly is effectively operated by a conventional chain-driven roller blind arrangement. Such an arrangement is described in U.S. Pat. No. 7,100,668, the contents of which are incorporated herein in their entirety.

In an alternative embodiment, the roller tube may form part of a spring driven roller blind. Thus, the assembly may further include a spring assembly housed within the roller tube which is adapted to bias the roller blind sheet to a retracted configuration. Such roller tubes typically also include a releasable lock mechanism to lock selectively the roller sheet in a desired configuration.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

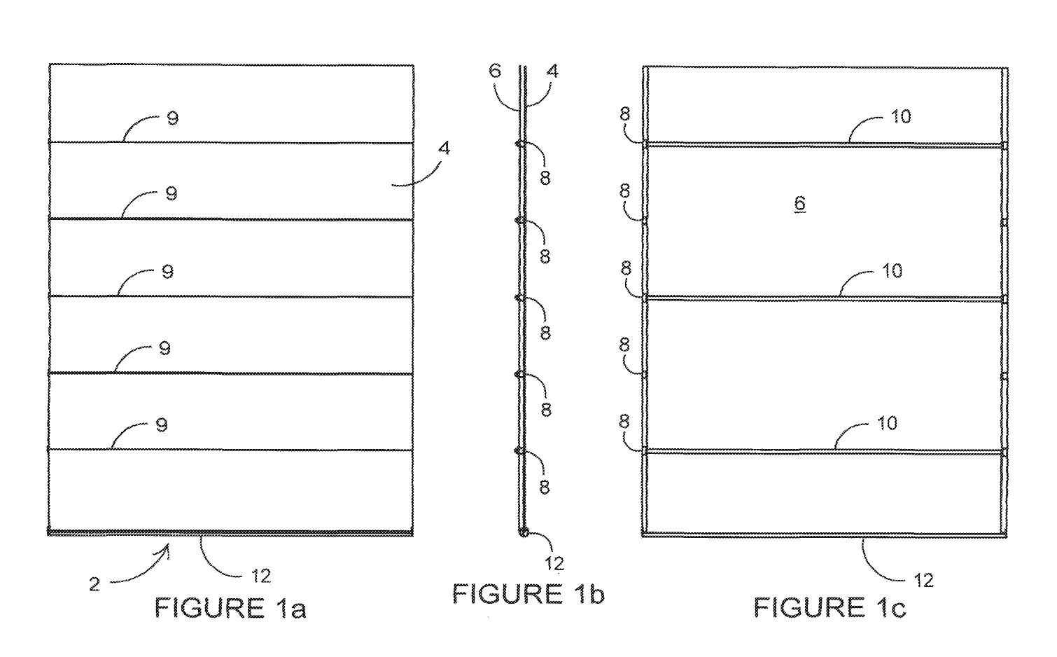

FIG. 1a is a front elevational view of a blind assembly according to the invention showing the Roman blind sheet;

FIG. 1b is a side elevational view of the assembly of FIG. 1, showing the Roman blind sheet and the roller blind sheet;

FIG. 1c is a rear elevational view of the assembly of FIG. 1, showing the roller blind sheet and the channel-defining elements;

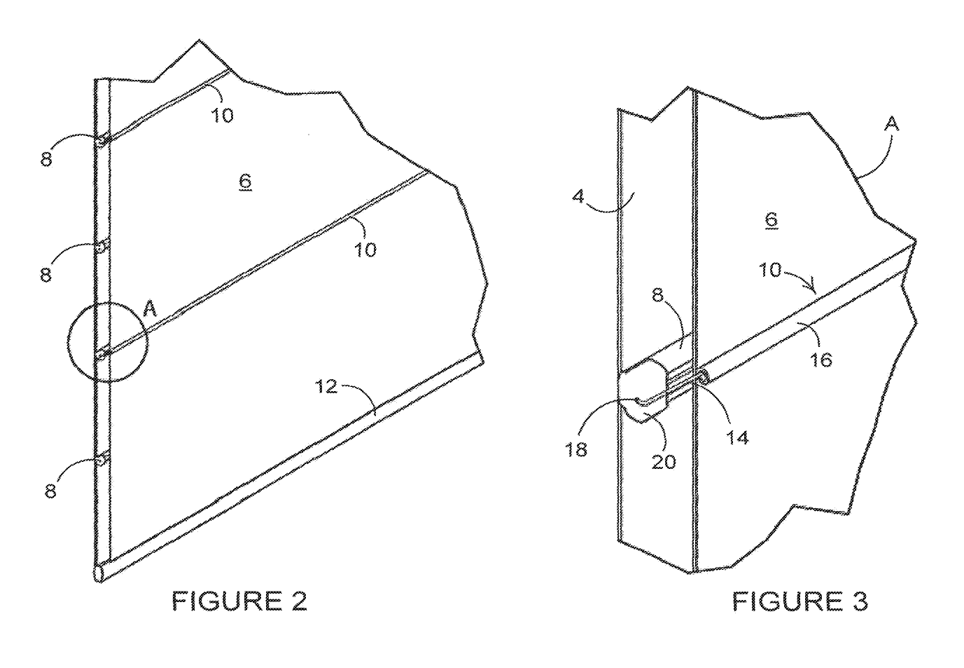

FIG. 2 is a perspective view of a portion of the blind assembly shown in FIG. 1;

FIG. 3 is an enlarged view of part of the assembly shown in FIG. 2;

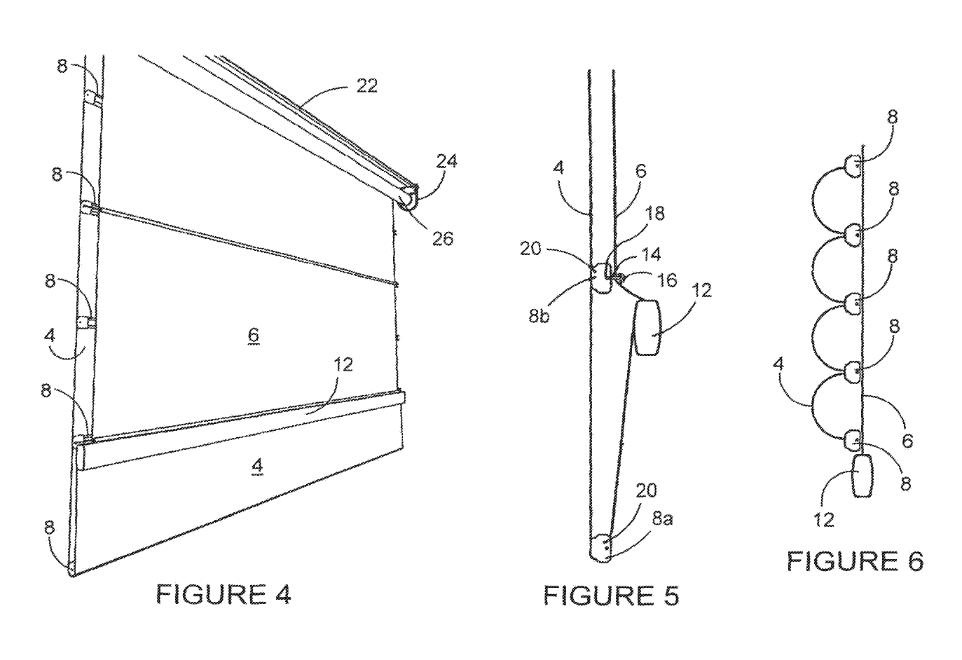

FIG. 4 is a perspective view of the blind assembly shown in FIG. 1, including a headrail;

FIG. 5 is a side elevational view of a portion of the blind assembly showing the fold achieved by an intermediate horizontal bar;

FIG. 6 is a side elevational view of a second embodiment of the blind assembly;

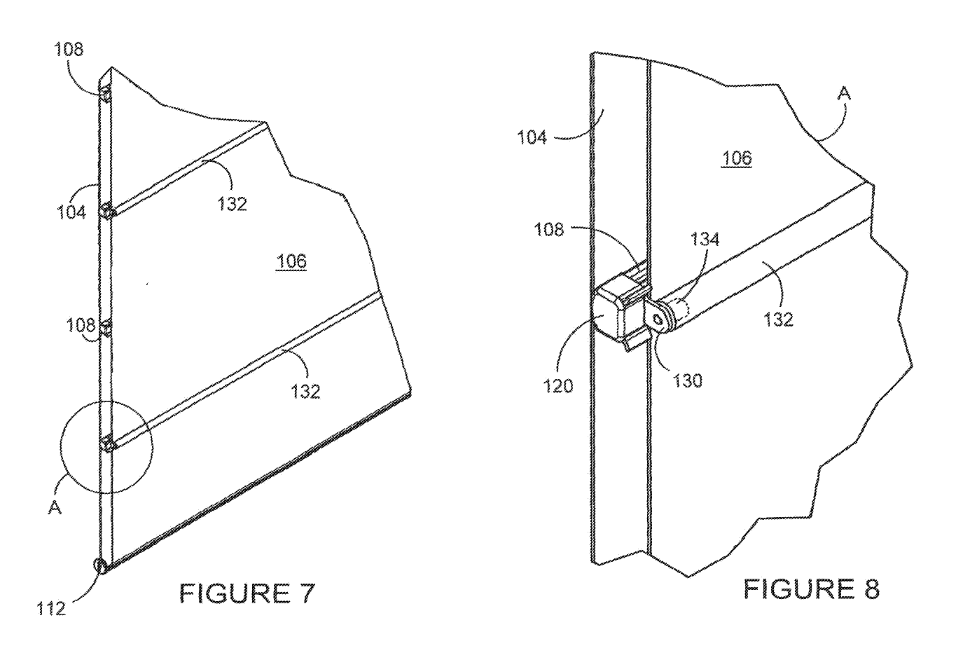

FIG. 7 is a perspective view of a third embodiment of the blind assembly, showing an alternative channel-defining element assembly; and

FIG. 8 is an enlarged view of part of the assembly shown in FIG. 7.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIGS. 1a, 1b and 1c show a blind assembly 2 according to a first embodiment of the invention. The blind assembly 2 includes an inwardly facing (hereinafter “front”) Roman blind sheet 4 and an outwardly facing (hereinafter “rear”) roller blind sheet 6.

The Roman blind sheet 4 includes a plurality of equally spaced horizontal bars 8 which provide the Roman blind sheet with its characteristic folds when in a retracted configuration and which provide the characteristic creases 9 when in a deployed configuration (FIG. 1a). The horizontal bars 8 grip a portion of the Roman blind sheet 4 within a sheet-receiving slot (not shown) formed in each horizontal bar 8. Each slot includes a rod (not shown) located therein and the rod has a diameter which is greater than the width of the slot. A portion of the Roman blind sheet 4 is inserted into each slot and then a respective rod is inserted axially into the slot from an open end thereof to lock the sheet 4 in the slot. Such an arrangement is well known to those skilled in the art (see, for example, slot 6 and rod 36 in WO2007/140526, the contents of which are incorporated herein in their entirety) and is not shown in detail herein.

As can be seen from FIG. 1c, alternate horizontal bars 8 (i.e. the lifting bars) carry a channel-defining element 10 which extends substantially the entire length of the bar 8 and is arranged parallel thereto. The channel-defining element 10 is described in more detail hereinbelow. The horizontal bars 8 which do not carry a channel-defining element 10 are referred to as intermediate horizontal bars and the effect they have on the folding of the Roman blind sheet 4 is shown in more detail in FIG. 5 and discussed in detail below.

The Roman blind sheet 4 and the roller blind sheet 6 both share a common bottom bar 12 which is secured to both sheets 4, 6.

As shown in FIG. 2, the roller blind sheet 6 is slightly narrower than the Roman blind sheet 4.

FIG. 3 shows a magnified portion of the assembly shown in FIG. 2 and shows in more detail the channel-defining element 10. The channel-defining element 10 includes a polymeric single filament cable 14 surrounded along the majority of its length by a shroud 16. The shroud 16 is arranged to be rotatable about the cable 14. Thus, the cable 14 acts as an axle for the shroud 16.

Both the cable 14 and the shroud 16 are formed from a transparent polymer.

The cable 14 is held taught by an anchor 18 located at each end of the horizontal bar 8. The anchors 18 form part of end caps 20 provided at respective ends of the horizontal bar 8. In this arrangement, the cable 14 is maintained substantially parallel to the horizontal bar 8, but defines a gap therefrom. The gap is sufficiently wide (i.e. the spacing between the bar 8 and the cable 14) that the roller sheet 6 is able to move vertically within the gap, but the bottom bar 12 is unable to pass through the gap.

The shroud 16 acts as a roller as the roller blind sheet 6 passes vertically through the gap and provides a smooth passage therethrough.

The blind assembly 2 further includes a headrail 22 as shown in FIG. 4. The headrail 22 includes a slot (not shown) within which the upper end of the Roman blind sheet 4 is secured. The headrail also includes a pair of brackets 24 to which are rotatably coupled the idle end and control end of a roller tube 26, around which is wound the roller blind sheet 6. The arrangement of the roller blind tube 26 between the brackets 24 carried by the headrail 22 is a conventional arrangement: the idle end is free to rotate relative to its bracket 24 and the rotation of the control end relative to its bracket 24 is controlled by an operating chain and a clutch arrangement (not shown). As such roller blind arrangements are well known (see for example U.S. Pat. No. 7,100,668, the contents of which are incorporated herein in their entirety), it will not be described in detail herein.

In use, the blind assembly 2 is retracted by winding the operating chain (not shown) of the roller blind in a first sense. This causes the clutch to release and the roller tube 26 to rotate in the same sense as the operating chain. Rotation of the roller tube 26 causes the roller blind sheet 6 secured to the roller tube 26 to be wound onto the tube and the bottom bar 12 to rise. As the bottom bar 12 rises, it by-passes the first (intermediate) horizontal bar 8, as this bar does not include a channel-defining element 10 and continues to the next horizontal bar 8. This horizontal bar 8 is a lifting bar and includes a channel-defining element 10, which is engaged by the bottom bar 12, as the bottom bar 12 is unable to pass through the channel defined between the channel-defining element 10 and the horizontal bar 8.

In this position, a loop of the Roman blind sheet 4 hangs below the bottom bar 12 and is urged into an aesthetically pleasing folded configuration by the lowermost horizontal bar 8 which was by-passed by the bottom bar 12. This arrangement is shown in FIG. 5, in which the first horizontal bar (an intermediate bar) is labelled 8a and the second horizontal bar (a lifting bar) which includes the channel-defining element 10 is labelled 8b. It can be seen that the horizontal bar 8a causes the Roman blind sheet 4 to fold about it such that the bar 8a defines the nadir of the loop.

As the bottom bar 12 continues to rise, it by-passes each intermediate horizontal bar 8a and engages each lifting horizontal bar 8b in the manner described above until the Roman blind sheet 4 is fully retracted. In the fully retracted configuration, the Roman blind sheet includes a plurality of folds defined by the by-passed, intermediate horizontal bars 8a.

To deploy the blind assembly, the operating chain is rotated in the opposite sense, which causes the roller tube 26 to rotate in that sense. Rotation of the roller tube 26 in this way causes the roller blind sheet 6 to unwind from the roller tube 26 and the bottom bar 12 to descend vertically. As the bottom bar 12 descends vertically, the horizontal bars 8 also descend to the extent permitted by the Roman blind sheet 4 to which they are secured. This process continues until the user stops rotating the operating cord or until the blind assembly 2 is fully deployed.

In an alternative embodiment (not shown), the roller blind includes a spring tension apparatus within the roller tube and a lock element to lock the roller tube in a desired rotational position. In this embodiment, the Roman blind assembly is deployed by urging the bottom bar 12 downwards until it is in the desired position, at which point the downward force upon the bottom bar 12 is removed and the lock element engages the roller tube to prevent further rotation resulting in the retraction of the blind assembly. The action of urging downwards the bottom bar charges or energises the spring arrangement within the roller tube, which biases the roller tube back to a retracted position. To return the blind assembly to the fully retracted position, or a position between the current position and the fully retracted position, the lock element is released (typically by tugging the bottom bar gently downwards) and the roller tube is allowed to rotate, being driven by the spring assembly, in a direction which winds the roller blind sheet onto the roller tube. Such spring-assisted roller blind arrangements are well known, for example, see US 2008/0173499, the contents of which are incorporated herein in their entirety.

A second embodiment of the invention is shown in FIG. 6. In this embodiment, all of the horizontal bars 8 include the channel-defining element 10. In this embodiment, the Roman blind sheet 4 is a coated fabric and without the presence of the intermediate horizontal bars 8a urging the folds into the configuration shown in FIG. 5, the folds bow outwards and define a number of loops in the Roman fabric sheet 4, rather than folds. This may or may not be desirable, depending on the aesthetic effect that the blind assembly 2 is attempting to achieve.

This second embodiment may form part of an assembly which includes a winding chain and clutch arrangement or a spring assisted roller blind assembly as described above.

A third embodiment of the invention is shown in FIGS. 7 and 8. These figures show an alternative channel-defining element assembly. In FIGS. 7 and 8, the components that correspond to the components of the first embodiment shown in FIGS. 2 and 3 and described hereinabove are given the same reference numbers, but with a “100” prefix. Thus, the Roman blind sheet 4 of FIG. 2 becomes Roman blind sheet 104 in FIG. 7 and so on.

Instead of end caps 20 which include anchors 18 for the cable 14, the lifting bars of this element include a pair of end caps 120 which each carry a bracket 130 projecting rearwardly from the respective and cap 120 such that they extend beyond the roller blind sheet 106. Each bracket 130 has rotationally coupled thereto one end of a hollow rod 132. Each end of the rod 132 has received therein a stub axle 134 which projects inwardly from the respective bracket 130. As can be seen from FIG. 8, the stub axle 134 consists of a short cylindrical projection configured to fit within the hollow core of the rod 132 such that the rod 132 is able to rotate about the stub axle 134.

The rod 132 may be released from the stub axle 134 by deflecting the rod 132 laterally (i.e. perpendicularly to the longitudinal axis of the rod) until the stub axle 134 is no longer located within its hollow core, and may be reattached by reversing this step. In practice, the length of the stub axle 134 will be such that the rod 132 will be released from the stub axle 134 by a lateral deflection which is less than that required to insert a child's head between the rod 132 and the horizontal bar 108. In this way, a child is unable to insert his or her head between the rod 132 and the horizontal bar 108 without the rod 132 becoming disengaged from the stub axle 134 and thus detached from the horizontal bar 108.

The skilled person will appreciate from FIG. 8 that the rod 132 is slightly shorter than the horizontal bar 108 and end cap 120 as the bracket 130 is located on the inward side (i.e. the right hand side as shown in FIG. 8) of the end cap 120. However, the rod 132 (and therefore also the roller blind sheet 106) may be substantially the same width as the horizontal bar 108 and end cap 120 (and therefore substantially the same width as the Roman blind sheet 104) if the end cap 120 is modified slightly to locate the bracket 130 towards the outer side of the end cap 120 (i.e. the left hand side of the end cap 120 as shown in FIG. 8). Such a modification is well within the ability of the skilled man and is within the scope of the present invention.

1. A blind assembly including a Roman blind sheet secured at one end thereof to a headrail, wherein the Roman blind sheet carries a plurality of horizontal bars arranged in a spaced relationship; and a roller blind sheet secured at one end thereof to a roller tube rotatably coupled to the headrail, the roller blind sheet including at the opposite end thereof a bottom bar, the roller blind bottom bar being coupled to the Roman blind sheet such that rotation of the roller tube causes the roller blind sheet to be raised or lowered and a consequent raising or lowering of the Roman blind sheet, wherein the horizontal bars extend across substantially the entire width of the Roman blind sheet and each horizontal bar includes a Roman blind fabric engagement element in the form of a fabric receiving slot extending substantially the entire length of the bar; wherein at least one of the horizontal bars further includes a channel-defining element which defines a channel between a body portion of the horizontal bar and the channel-defining element; and wherein the roller blind sheet is located in use within the channel.

2. A blind assembly according to claim 1, wherein the channel is configured to permit vertical movement of the roller blind sheet through the channel, but to prevent the roller blind bottom bar from passing through the channel.

3. A blind assembly according to claim 1, wherein the channel-defining element includes a rotatable rod or tube.

4. A blind assembly according to claim 1, wherein the channel-defining element is releasably coupled to the body portion of the horizontal bar.

5. A blind assembly according to claim 4, wherein the horizontal bar includes a pair of opposed mounting brackets and the channel-defining element is releasably coupled to the brackets.

6. A blind assembly according to claim 3, wherein the channel-defining element is rotatable about its longitudinal axis.

7. A blind assembly according to claim 1, wherein the channel-defining element includes a cable which extends substantially the entire length of the horizontal bar.

8. A blind assembly according to claim 7, wherein the cable includes a coaxial shroud rotatably coupled thereto.

9. A blind assembly according to claim 1, wherein alternate horizontal bars include the channel-defining element.

10. A blind assembly according to claim 1, wherein the Roman blind sheet includes a bottom bar.

11. A blind assembly according to claim 10, wherein the roller blind bottom bar and the Roman blind bottom bar together form a common bottom bar.

12. A blind assembly according to claim 1, wherein the roller blind bottom bar is slidably coupled to the Roman blind sheet.

13. A blind assembly according to claim 1, wherein the Roman blind sheet is coated or impregnated with a polymeric resin and/or is a laminated sheet containing two or more sheet elements bonded together.

14. A blind assembly according to claim 1, wherein the assembly further includes a drive wheel connected to the roller tube, a clutch and a manually operable operating chain connected to the drive wheel, such that the roller tube is capable of being rotated by the operating chain and the clutch is capable of preventing undesired rotation of the roller tube.

15. A blind assembly according to claim 1, wherein the assembly further includes a spring assembly housed within the roller tube which is adapted to bias the roller blind sheet to a retracted configuration.
